(19) United States
(12) Patent Application Publication
(10) Pub. No.: US 2013/0230107 A1
(43) Pub. Date: Sep. 5, 2013

(54) METHOD FOR DETERMINING MOTION VECTOR AND ASSOCIATED APPARATUS

(71) Applicant: Hung-Ching Chen, Tainan City (TW)

(72) Inventor: Hung-Ching Chen, Tainan City (TW)

(21) Appl. No.: 13/409,123

(22) Filed: Mar. 1, 2012

(51) Int. Cl. H04N 7/32

(52) U.S. Cl. 375/240.16; 375/E07.243

(57) ABSTRACT

A method for determining a motion vector of a specific macro-block of an image frame includes: determining a plurality of motion vectors of a plurality of macro-blocks of the image frame, wherein the macro-blocks comprise at least the specific macro-block and its neighboring macro-blocks; determining weighting factors of the macro-blocks; for a first motion vector of the plurality of motion vectors, determining a cost of the first motion vector according to at least a portion of the weighting factors and the motion vectors; for a second motion vector of the plurality of motion vectors, determining a cost of the second motion vector according to at least a portion of the weighting factors and the motion vectors; and refining determination of the motion vector of the specific macro-block according to the cost of the first motion vector and the cost of the second motion vector.

### BACKGROUND OF THE INVENTION

1. Field of the Invention

The present invention relates to an image processing method, and more particularly, to a method for determining motion vectors and an associated apparatus.

2. Description of the Prior Art

The motion estimation and motion compensation (MEMC) technique is used to solve motion blur issues. Because the conventional block-based matching algorithm used for motion estimation in the conventional art cannot identify foreground and background objects, however, the determined motion vector of the foreground objects may be influenced by the background motion vector. When moving speeds of the foreground and background objects are different, the edges of the foreground objects may be blurred, which degrades the display quality.

### SUMMARY OF THE INVENTION

It is therefore an objective of the present invention to provide a method for determining motion vectors and an associated apparatus, which can refine the determined motion vector to solve the above-mentioned problems.

According to one embodiment of the present invention, a method for determining a motion vector of a specific macro-block of an image frame comprises: determining a plurality of motion vectors of a plurality of macro-blocks of the image frame, wherein the macro-blocks comprise at least the specific macro-block and its neighboring macro-blocks; and determining weighting factors of the macro-blocks; for a first motion vector of the plurality of motion vectors, determining a cost of the first motion vector according to at least a portion of the weighting factors and the motion vectors; for a second motion vector of the plurality of motion vectors, determining a cost of the second motion vector according to at least a portion of the weighting factors and the motion vectors; and refining determination of the motion vector of the specific macro-block according to the cost of the first motion vector and the cost of the second motion vector.

According to another embodiment of the present invention, an apparatus for determining a motion vector of a specific macro-block of an image frame comprises a motion vector determination unit, a calculation unit and a refinement unit. The motion vector determination unit is utilized for determining weighting factors of the macro-blocks, and for determining a plurality of motion vectors of a plurality of macro-blocks of the image frame, wherein the macro-blocks comprise at least the specific macro-block and its neighboring macro-blocks. The calculation unit is coupled to the motion vector determination unit, where for a first motion vector of the plurality of motion vectors, the calculation unit determines a cost of the first motion vector according to at least a portion of the weighting factors and the motion vectors; and for a second motion vector of the plurality of motion vectors, the calculation unit determines a cost of the second motion vector according to at least a portion of the weighting factors and the motion vectors. The refinement unit is coupled to the motion vector determination unit and the calculation unit, and is utilized for refining determination of the motion vector of the specific macro-block according to the cost of the first motion vector and the cost of the second motion vector.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an apparatus according to one embodiment of the present invention.

FIG. 2 is a flowchart of a method according to one embodiment of the present invention.

FIG. 3 is a diagram showing a plurality of macro-blocks of an image frame.

FIG. 4 shows a macro-block and its matching macro-block.

FIG. 5 is a diagram illustrating weighting factors and motion vectors of the macro-blocks.

### DETAILED DESCRIPTION

Certain terms are used throughout the following description and claims to refer to particular system components. As one skilled in the art will appreciate, manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” The terms “couple” and “couples” are intended to mean either an indirect or a direct electrical connection. Thus, if a first device couples to a second device, that connection may be through a direct electrical connection, or through an indirect electrical connection via other devices and connections.

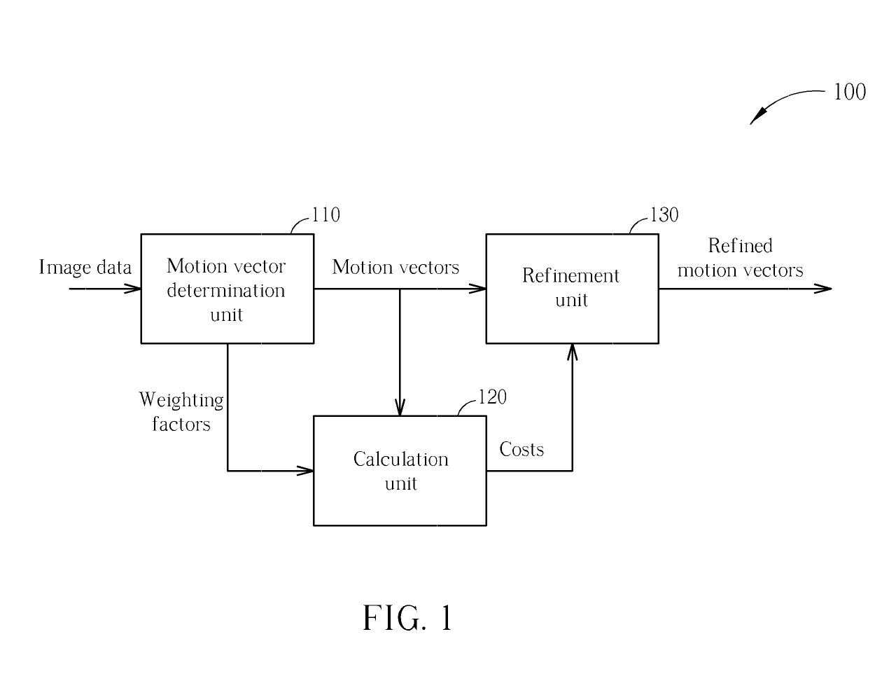

Please refer to FIG. 1, which illustrates an apparatus 100 according to one embodiment of the present invention. As shown in FIG. 1, the apparatus 100 comprises a motion vector determination unit 110, a calculation unit 120 and a refinement unit 130. In this embodiment, the apparatus 100 can be built in a television (TV), a notebook or any other display.

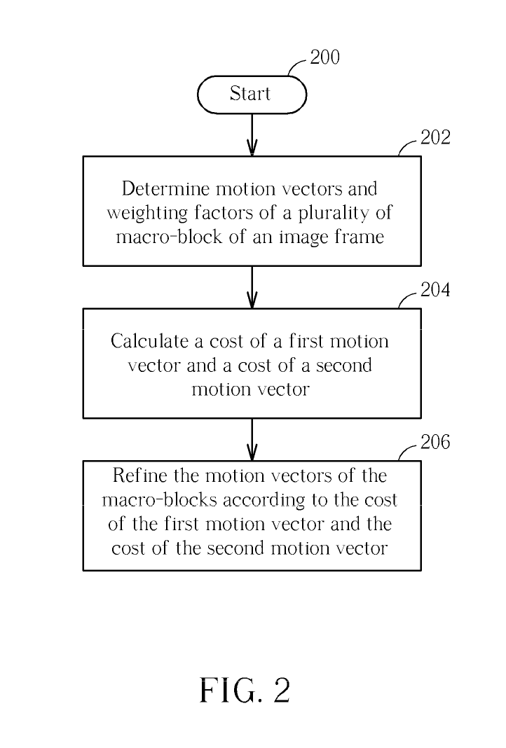

Please refer to FIGS. 1 and 2 together. FIG. 2 is a flowchart of a method according to one embodiment of the present invention. It is noted that, provided the results are substantially the same, the steps are not limited to be executed according to the exact order shown in FIG. 2. Referring to FIG. 2, the flow is described as follows.

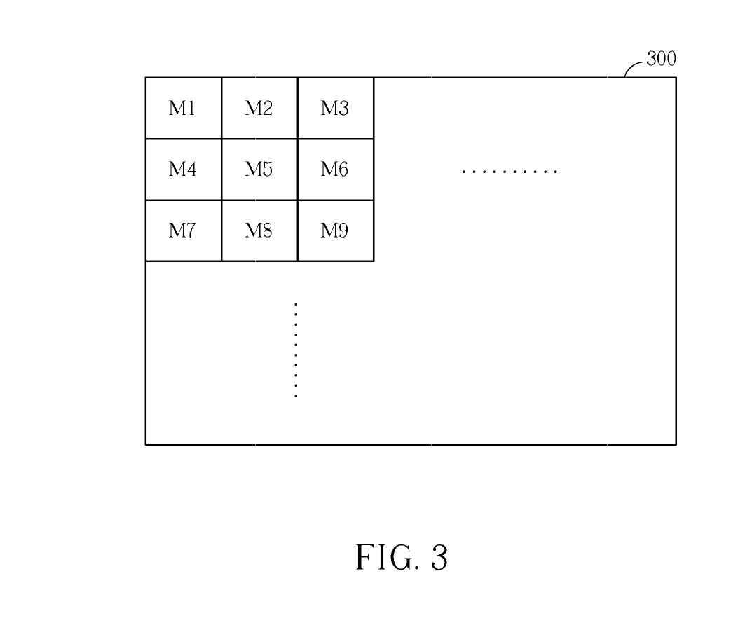

In Step 200, the flow starts. In Step 202, the motion vector determination unit 110 receives image data and determines motion vectors and weighting factors of a plurality of macro-blocks of an image frame. For example, taking an image frame 300 shown in FIG. 3 as an example, the motion vector determination unit 110 determines the motions vectors of the macro-blocks M1-M9, where the motion vectors can be determined by a cost function called sum of absolute difference (SAD), which is obtained as follows:

$$S A D ( x , y ) = {\sum }_{i = i 0}^{i 1} {\sum }_{j = j 0}^{j 1} \vert {C}_{i , j} - {P}_{i + x , j + y} \vert ,$$

where (x, y) is a candidate motion vector in a search range of a next N image frame (N can be any appropriate positive integer), (i1-i0)*(j1-j0) is the size of a macro-block of the image frame 300, Cij is a pixel in the macro-block, and Pi+x, j+y is a pixel in the search range of the next N image frame. For each of the macro-blocks M1-M9, the motion vector determination unit 110 can determine the appropriate motion vector of each of the macro-block M1-M9, which minimizes the cost function. Because the method of determining the motion vectors should be known by a person skilled in this art, further descriptions are omitted here.

The above-mentioned SAD cost function is for illustrative purposes only, and is not to be a limitation of the present invention. In other embodiments, the motion vector determination unit 110 can use another cost function such as sum of squared difference (SSD) to determine the motion vectors of the macro-blocks. These alternative designs also fall within the scope of the present invention.

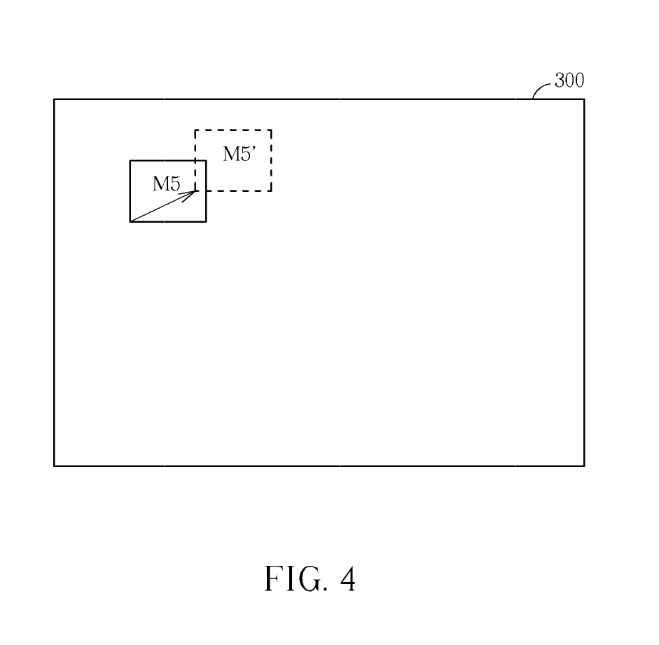

In this embodiment, the motion vector determination unit 110 further generates weighting factors of the macro-blocks by using the SAD cost function. Taking the macro-block M5 shown in FIG. 4 as an example, assuming that the macro-block M5 has a matching macro-block M5′ in the next N image frame (i.e. macro-block M5′ is the most similar to the macro-block M5), the weighting factor can be derived from a SAD value of the macro-block M5 and the matching macro-block M5′, where the SAD value is the sum of absolute differences between pixels of the macro-block M5 and the matching macro-block M5′. In addition, in this embodiment, the weighting factor can be the SAD value, but this is not meant to be a limitation of the present invention.

In Step 204, the calculation unit 120 determines a cost of a first motion vector and a cost of a second motion vector, where the first motion vector can be a background motion vector, and the second motion vector can be a motion vector of a foreground object. In this embodiment, taking the macro-block M5 as a specific macro-block which is to be refined in the following process, the calculation unit 120 can calculate differences between the motion vectors of the macro-blocks (M1-M4 and M6-M9) and the first motion vector, and utilize the weighting factors of the macro-blocks (M1-M4 and M6-M9) to calculate a weighting summation of the differences between the motion vectors of the macro-blocks (M1-M4 and M6-M9) and the first motion vector to generate the cost of the first motion vector. Similarly, the calculation unit 120 can further calculate differences between the motion vectors of the macro-blocks (M1-M4 and M6-M9) and the second motion vector, and utilize the weighting factors of the macro-blocks (M1-M4 and M6-M9) to calculate a weighting summation of the differences between the motion vectors of the macro-blocks (M1-M4 and M6-M9) and the second motion vector to generate the cost of the second motion vector.

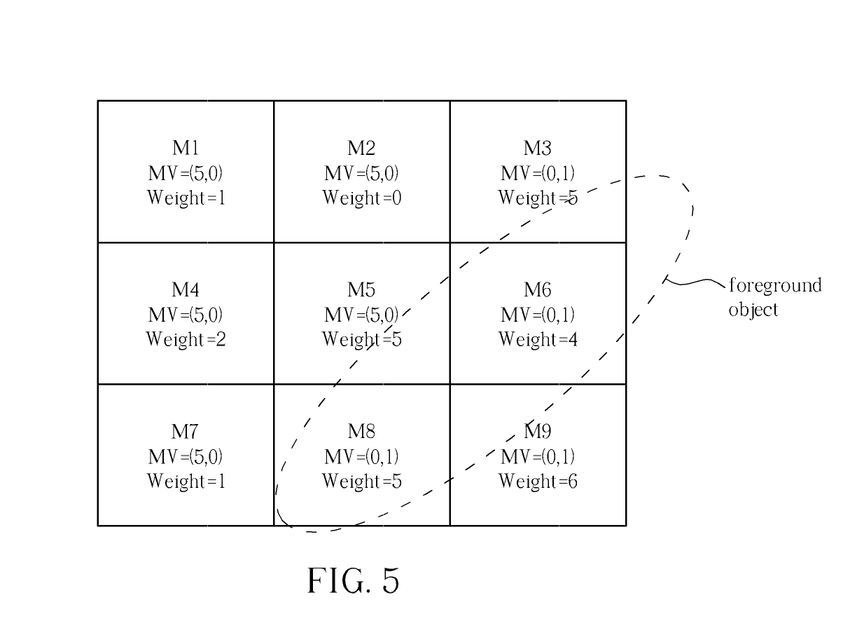

Taking FIG. 5 as an example, weighting factors and motion vectors of the macro-blocks M1-M9 of the image frame 300 are illustrated. As shown in FIG. 5, the background motion vector is (5, 0) and the motion vector of the foreground object is (0, 1). Assuming that the difference between the motion vector (5, 0) and (0, 1) is represented as a value “6” (note: not to be a limitation of the present invention), the cost of the first motion vector (i.e. cost of the background motion vector) COST1, and the cost of the second motion vector (i.e. cost of the motion vector of the foreground object) COST2 can be calculated as follows:

COST1=weighting summation of the differences between the macro-blocks (M1-M4 and M6-M9) and the first motion vector (5, 0)=0*1+0*0+6*5 +0*2+6*4+0*1+6*5+6*6=120.

COST2=weighting summation of the differences between the macro-blocks (M1-M4 and M6-M9) and the second motion vector (0, 1)=6*1+6*0+0*5+6*2+0*4+6*1+0*5+0*6=30.

Then, in Step 206, the refinement unit 130 refines the motion vector of the macro-block M5 by a selected motion vector selected from the first motion vector and the second motion vector according to the cost of the first motion vector and the cost of the second motion vector. In this embodiment, when the cost of the first motion vector is smaller than the cost of the second motion vector, the selected motion vector is the first motion vector, and when the cost of the second motion vector is smaller than the cost of the first motion vector, the selected motion vector is the second motion vector. Taking FIG. 5 as an example, because the cost of the second motion vector COST2 (which is equal to “30”) is smaller than the cost of the first motion vector COST1 (which is equal to “120”), the motion vector of the macro-block M5 is re-determined to be (0, 1) which is the same as the motion vector of the foreground object.

Similarly, all the macro-blocks in the image frame 300 sequentially undergo the same steps as above to refine their motion vectors. After these refining steps, the motion vectors of the macro-blocks including the edges of the foreground object in the image frame 300 can be appropriately refined, so blurring on the edges of foreground object in the image frame 300 will be reduced, and the display quality is therefore improved.

Briefly summarized, in the method for determining motion vectors and associated apparatus of the present invention, the motion vectors of the macro-blocks of an image frame are determined, and then these motion vectors are refined according to a cost of a background motion vector and a cost of a motion vector of a foreground object. The blurring on edges of the foreground object will therefore be reduced, and the display quality is thereby improved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for determining a motion vector of a specific macro-block of an image frame, comprising:
determining a plurality of motion vectors of a plurality of macro-blocks of the image frame, wherein the macro-blocks comprise at least the specific macro-block and its neighboring macro-blocks;
determining weighting factors of the macro-blocks;
for a first motion vector of the plurality of motion vectors, determining a cost of the first motion vector according to at least a portion of the weighting factors and the motion vectors;
for a second motion vector of the plurality of motion vectors, determining a cost of the second motion vector according to at least a portion of the weighting factors and the motion vectors; and
refining determination of the motion vector of the specific macro-block according to the cost of the first motion vector and the cost of the second motion vector.

2. The method of claim 1, wherein the step of refining determination of the motion vector of the specific macro-block comprises:
refining the motion vector of the specific macro-block by a selected motion vector selected from the first motion vector and the second motion vector according to the cost of the first motion vector and the cost of the second motion vector.

3. The method of claim 1, wherein the step of determining the weighting factors of the macro-blocks comprises:
for each macro-block of the image frame and its matching macro-block in another image frame, obtaining a computation value derived from a difference between the macro-block and its matching macro-block; and
generating the weighting factors of the macro-blocks according to computation values of the macro-blocks.

4. The method of claim 3, wherein the computation values are sum of absolute differences (SAD) values.

5. The method of claim 1, wherein the step of determining the cost of the first motion vector and the cost of the second motion vector comprises:
calculating differences between at least a portion of the motion vectors and the first motion vector, and calculating differences between at least a portion of motion vectors and the second motion vector;
utilizing the weighting factors of the macro-blocks to calculate a weighting summation of the differences between the portion of motion vectors and the first motion vector to generate the cost of the first motion vector;
and utilizing the weighting factors of the macro-blocks to calculate a weighting summation of the differences between the portion of motion vectors and the second motion vector to generate the cost of the second motion vector.

6. The method of claim 5, wherein the step of refining determination of the motion vector of the specific macro-block comprises:
refining the motion vector of the specific macro-block by a selected motion vector selected from the first motion vector and the second motion vector according to the cost of the first motion vector and the cost of the second motion vector, wherein when the cost of the first motion vector is smaller than the cost of the second motion vector, the selected motion vector is the first motion vector, and when the cost of the second motion vector is smaller than the cost of the first motion vector, the selected motion vector is the second motion vector.

7. An apparatus for determining a motion vector of a specific macro-block of an image frame, comprising:
a motion vector determination unit, for determining weighting factors of a plurality of macro-blocks, and for determining a plurality of motion vectors of the macro-blocks of the image frame, wherein the macro-blocks comprise at least the specific macro-block and its neighboring macro-blocks; and
a calculation unit, coupled to the motion vector determination unit, wherein for a first motion vector of the plurality of motion vectors, the calculation unit determines a cost of the first motion vector according to at least a portion of the weighting factors and the motion vectors; and for a second motion vector of the plurality of motion vectors, the calculation unit determines a cost of the second motion vector according to at least a portion of the weighting factors and the motion vectors; and
a refinement unit, coupled to the motion vector determination unit and the calculation unit, for refining determination of the motion vector of the specific macro-block according to the cost of the first motion vector and the cost of the second motion vector.

8. The apparatus of claim 7, wherein the refinement unit refines the motion vector of the specific macro-block by a selected motion vector selected from the first motion vector and the second motion vector according to the cost of the first motion vector and the cost of the second motion vector.

9. The apparatus of claim 7, wherein for each macro-block of the image frame and its matching macro-block in another image frame, the motion vector determination unit obtains a computation value derived from a difference between the macro-block and its matching macro-block, and generates the weighting factors of the macro-blocks according to computation values of the macro-blocks.

10. The apparatus of claim 9, wherein the computation values are sum of absolute differences (SAD) values.

11. The apparatus of claim 7, wherein the calculation unit calculates differences between at least a portion of the motion vectors and the first motion vector, and calculating differences between at least a portion of motion vectors and the second motion vector; and the calculation unit utilizes the weighting factors of the macro-blocks to calculate a weighting summation of the differences between the portion of motion vectors and the first motion vector to generate the cost of the first motion vector; and the calculation unit utilizes the weighting factors of the macro-blocks to calculate a weighting summation of the differences between the portion of motion vectors and the second motion vector to generate the cost of the second motion vector.

12. The apparatus of claim 11, wherein the refinement unit refines the motion vector of the specific macro-block by a selected motion vector selected from the first motion vector and the second motion vector according to the cost of the first motion vector and the cost of the second motion vector, wherein when the cost of the first motion vector is smaller than the cost of the second motion vector, the selected motion vector is the first motion vector, and when the cost of the second motion vector is smaller than the cost of the first motion vector, the selected motion vector is the second motion vector.
